(19) United States
(12) Patent Application Publication
(10) Pub. No.: US 2007/0119072 A1
(43) Pub. Date: May 31, 2007

(54) Single body washing machine and dryer device and a method for controlling the same

(76) Inventor: Dong Won Kim, Gwangmyeong-si (KR)

Correspondence Address: MCKENNA LONG & ALDRIDGE LLP;Song K. Jung, 1900 K. Street, N.W., Washington, DC, 20006, US

(21) Appl. No.: 11/603,017

(22) Filed: Nov. 22, 2006

(30) Foreign Application Priority Data
Nov. 25, 2005 (KR) 10-2005-0113461

(51) Int. Cl. F26B 19/00; F26B 11/02

(52) U.S. Cl. 34/596; 34/550

(57) ABSTRACT

The present invention relates to a single body washing machine and dryer device, and more particularly, to a washing machine component and dryer component which are fabricated as a single body to enable the combination washing machine component and the dryer component to perform drying functions using a single heater that is shared between the two components. The single body washing machine and dryer device includes a cabinet for forming an inside space, a tub on one side of the inside space of the cabinet, a washing and drying combination drum rotatably mounted in the tub, a drying drum rotatably mounted on the other side of the inside space of the cabinet, and a heater for supplying hot air to the drying drum or the washing and drying combination drum selectively, or at the same time.

This application claims the benefit of the Korean Patent Application No. P2005-0113461, filed on Nov. 25, 2005, which is hereby incorporated by reference for all purposes as if fully set forth herein.

### BACKGROUND OF THE INVENTION

1. Field of the Invention

The present invention relates to a single body washing machine and dryer device, and more particularly, to a device in which the washing machine and dryer are two separate components housed within a single cabinet.

2. Discussion of the Related Art

In general, a washing machine includes a drum, rotatably mounted in a tub, and a driving unit for rotating the drum. Washing machines are classified based on the orientation of the drum, for example a top loading washing machine and a front loading washing machine.

In a top loading type washing machine, the drum is orientated along a vertical axis, where the laundry is placed in the drum through the top of the washing machine. In contrast, in a front loading type washing machine, the drum is orientated along a horizontal axis, where the laundry is placed in the drum through the front of the washing machine. Recently, a front loading type washing machine has become more widely selected over a top loading type washing machine because the front loading type washing machine offers a higher washing performance and a greater washing capacity, while reducing entanglement and damage to the laundry.

Developments have been made to front loading type washing machines, which include combining the drying functions of a dryer within the front loading type washing machine. One such combination washing machine ‘C’ is shown in FIG. 1. A drying module having a drying function is mounted within a front loading type washing machine, which allows the washing and drying of laundry to occur within a single device.

In typical laundering environments, the washing machines and dryers are used together. The washing machines and dryers may be arranged side by side; however this arrangement occupies too much space unnecessarily. One way that has been found to alleviate this problem is to stack the dryer ‘D’ on the washing machine ‘W,’ as shown in FIG. 2.

However, the related art has the following problems:

The combination type front loading washing machine ‘C’ takes too much time to dry the laundry due to the limitation of capacity of the drum, and size of a drying heater, and the like.

In the situation when the front loading dryer ‘D’ is stacked on a front loading type washing machine ‘W’ exclusively for washing, there is a limitation on increasing a drying capacity. The size of the dryer cannot exceed that of the washing machine because the arrangement would become unstable and increase the risk of the dryer falling off of the washing machine.

Even if the combination type front loading washing machine of FIG. 1 replaced the washing machine ‘W’ in the arrangement of FIG. 2, a significant amount of time would be required to dry the laundry in the combination washing machine compared to a dryer having a large capacity heater because the heater capacity of the combination washing machine is much smaller than a heater in a device having only a drying function. Moreover, two separate drying heaters would be required in this arrangement. With two heaters, the manufacturing and energy costs would significantly increase. In addition, proper alignment of the two separate devices would be critical. Thus, the installation process would be a lengthy and tedious task for the installation staff.

### SUMMARY OF THE INVENTION

Accordingly, the present invention is directed to a single body washing machine and dryer device and a method for controlling the same that substantially obviates one or more of the problems due to limitations and disadvantages of the related art.

An advantage of the present invention is to provide a single body washing machine and dryer device in which a washing machine and a dryer are fabricated as one body to enable the combination washing machine component and the dryer component to perform drying functions using a single heater that is shared between the two components.

Additional features and advantages of the invention will be set forth in the description which follows and in part will become apparent from the description, or may be learned by practice of the invention. These and other advantages of the invention may be realized and attained by the structure particularly pointed out in the written description and claims hereof as well as the appended drawings.

To achieve these and other advantages and in accordance with the purpose of the invention, as embodied and broadly described herein, a single body washing machine and dryer device comprising: a cabinet for forming an inside space; a tub on one side of the inside space of the cabinet; a washing and drying combination drum rotatably mounted in the tub; a drying drum rotatably mounted on the other side of the inside space of the cabinet; and a heater for supplying hot air to the drying drum or the washing and drying drum selectively, or at the same time.

In another aspect of the present invention, a method for controlling a single body washing machine and drying device comprising the steps of: a user selecting one of steps through a control panel from a step for drying only with a washing and drying drum, a step for drying only with a drying drum, and a step for drying with the washing and drying drum and the drying drum at the same time; operating a heater and an exhaust fan, and a microcomputer controlling a first flow passage control valve on a hot air duct, and a second flow passage control valve on an exhaust duct according to a drying step selected as above; and drying laundry and finishing the drying step.

It is to be understood that both the foregoing general description and the following detailed description of the present invention are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principle of the invention.

In the drawings:

FIG. 1 is a perspective view illustrating a related art combination washing machine having a drying function;

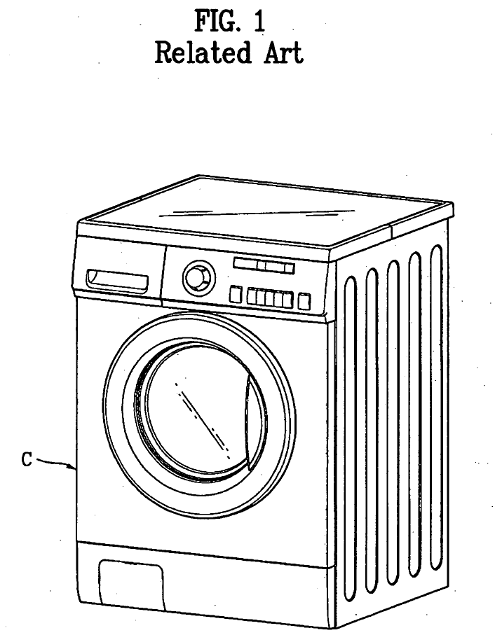

FIG. 2 is a perspective view of a related art dryer stacked on a related art washing machine in up/down direction;

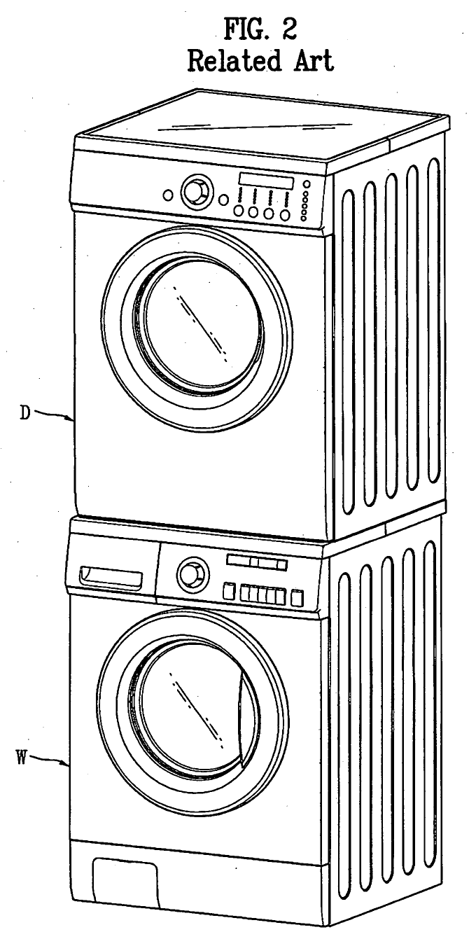

FIG. 3 is a perspective view of a single body washing machine and dryer device in accordance with an embodiment of the present invention; and

FIG. 4 is a sectional view of a single body washing machine and dryer in accordance with an embodiment of the present invention.

### DETAILED DESCRIPTION OF THE ILLUSTRATED EMBODIMENTS

Reference will now be made in detail to embodiments of the present invention, examples of which are illustrated in the accompanying drawings. Wherever possible, the same reference numbers will be used throughout the drawings to refer to the same or like parts.

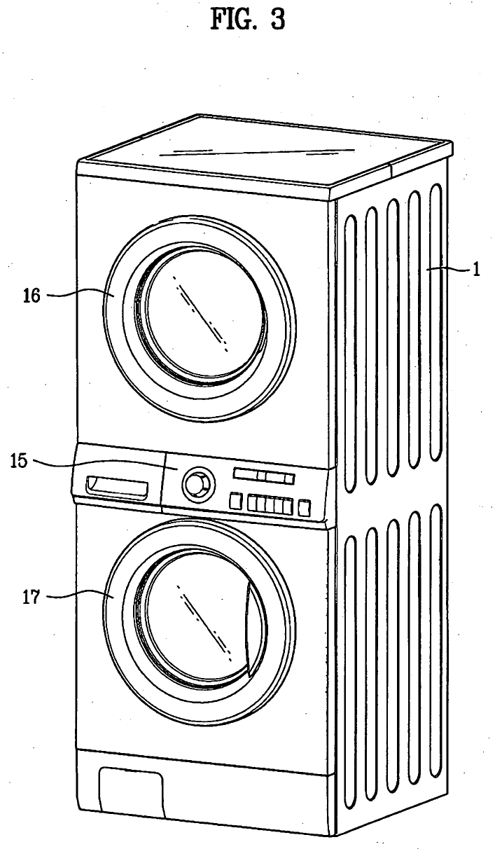

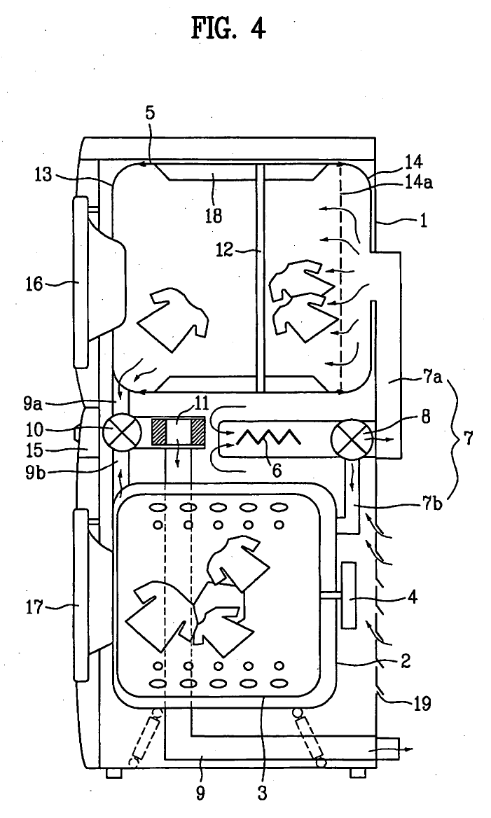

Referring to FIGS. 3 and 4, the single body washing machine and dryer device in accordance with an embodiment of the present invention includes a cabinet 1 for forming an inside space thereof, a washing machine component including: a tub 2 on one side of the inside space of the cabinet, and a washing and drying combination drum 3 rotatably mounted in the tub 2, and a dryer component including: a drying drum 5 rotatably mounted on the other side of the inside space of the cabinet 1.

The cabinet 1 of the single body washing machine and dryer device includes two sides, a top, a bottom, a rear and a front. Each side of the cabinet 1 covers both the washing and-drying combination tub 3 and the drying drum 5. The front of the cabinet 1 includes two doors 16 and 17 for allowing access to the washing and drying combination tub 3 and the drying drum 5. A control panel 15 is further included in the front of the cabinet 1. The control panel 15 includes individual controls for a user to select and control the desired cycles and functions of the washing machine component and the dryer component of the single body washing machine and dryer device. A display window in the control panel 15 displays the states of the laundering cycles for the washing machine and dryer.

For the washing machine component, it is preferable that the tub 2 is provided in a lower side of the inside space of the cabinet 1 for forming a stacked structure. The washing and drying combination drum 3 is rotatably mounted inside the tub 2 and a driving motor 4 is mounted to a rear wall of the tub 2 to drive the washing and drying combination drum 3.

For the dryer component, the drying drum 5 is rotatably mounted in an upper portion of the space inside of the cabinet 1. The drying drum 5 further includes lifters 18 secured on the inner surface of the drying drum 5.

A heater 6 for producing hot air to dry laundry in the drums is mounted inside the cabinet 1. The cabinet 1 also includes a hot air guide duct 7 for guiding the hot air produced by the heater 6 to the drying drum 5 and the washing and drying combination drum 3. The hot air guide duct 7 includes a first flow passage control valve 8 for controlling a flow passage of the hot air supplied to the drying drum 5 and the washing and drying combination drum 3 selectively, or at the same time.

An exhaust duct 9 is mounted inside the cabinet 1 for discharging the hot air supplied to the drying drum 5 or the washing and drying combination drum 3 outside of the cabinet 1. The exhaust duct 9 includes a second flow passage control valve 10 for controlling a flow passage of moisture rich air discharged from the drying drum 5 and the washing and drying combination drum 3 selectively, or at the same time.

The exhaust duct 9 includes an exhaust fan 11 that creates a suction force that circulates hot air into the drum and discharges the moisture rich air out of the drum.

It is preferable that the heater 6 which produces the hot air is provided at an inlet of the hot air guide duct 7.

There may be a first air supply flow passage 7a in the hot air guide duct 7, which is connected to a rear of the drying drum 5, and a second air supply flow passage 7b connected to the tub 2.

There may also be a first exhaust flow passage 9a in the exhaust duct 9, which is connected at the front side of the drying drum, and a second exhaust flow passage 9b connected to the front side of the tub 2.

The first and second flow passage control valves. 8 and 10, respectively, may be three-way valves which can open and close the two air supply flow passages 7a and 7b and the two exhaust flow passages 9a and 9b selectively, or at the same time. The first air supply flow passage 7a and the second air supply flow passage 7b are opened selectively or at the same time by the first flow passage control valve 8, and the first exhaust-flow passage 9a and the second exhaust flow passage 9b are opened selectively or at the same time by the second flow passage control valve 10.

The driving motor (not shown) for driving the drying drum 5 is fixedly secured to a motor mount bracket (not shown) on one side of the space inside the cabinet 1. In order to transmit a driving power from the driving motor to the drying drum 5, the driving motor and the drying drum 5 may be connected with a belt 12. The motor mount bracket. may be fabricated separately and fixedly secured to an inside wall of the cabinet 1.

The driving motor 4 for driving the washing and drying drum 3 may be a BLDC motor mounted on the rear wall of the tub 2.

On the front and rear of the drying drum 5, there are a front supporter 13 and a rear supporter 14 for supporting opposite edges of the drying drum which is rotatable.

It will be appreciated that although the washer and dryer combination drum 3 is shown in the drawings located at the bottom portion of the cabinet I and the dryer drum 5 is located in the upper portion of the cabinet 1, the positions may be alternatively reversed. Specifically, the washer and dryer combination drum 3 may be positioned in the upper portion of the cabinet 1 and the dryer drum 5 may be positioned in the lower portion of the cabinet 1.

The operation of the single body washing machine and dryer device will be described.

The single body washing machine and dryer device can perform the functions of a washing machine and dryer individually or at the same time, based on the selected position of the first flow passage control valve 8 and the second flow passage control valve 10. The single body washing machine and dryer device can further perform drying functions within the washing and drying combination drum 3 and the drying drum 5 individually or at the same time.

When the user selects the washing function from the control panel 15, a microcomputer sends a control signal to the first flow passage control valve 8 and the second flow passage control valve 10 to close the air supply flow passage 7 and the exhaust flow passage 9 tso the washing and drying combination drum 3. Washing water is then supplied to the washing and drying combination drum 3 through a water supply unit (not shown). Detergent is introduced into the washing and drying combination drum 3 and the selected washing cycle is performed. If the user selects a drying cycle to be performed at the same time as the washing cycle, the drying function is carried out in the drying drum 5.

In the single body washing machine and dryer device of the present invention, a user may select to perform a drying function in only the combination washing machine, only the dryer or both at the same time.

A drying process to be performed only in the combination washer will be described.

When the user selects a drying cycle at the control panel 15 to be performed only in the combination washing machine, a microcomputer sends a control signal to the first flow passage control valve 8 on the hot air guide duct 7 which closes the first air supply flow passage 7a connected to the drying drum 5, and opens the second air supply flow passage connected to the tub 2 of the washing machine.

A control signal is also sent to the second flow control valve 10 on the exhaust duct 9 to close the first exhaust flow passage connected to the drying drum 5, and open the second exhaust flow passage 9b connected to the tub 2 which surrounds the washing and drying combination drum 3.

The microcontroller also sends a control signal to turn on the exhaust fan 11 and the heater 6. After the exhaust fan 11 in turned on, external air is introduced through an external air inlet 19 in the rear of the cabinet 1. The suction force produced by the exhaust fan 11 draws external air into the inlet of the hot air guide duct 7 where it is heated as the air passes the heater 6. The air heated at the heater 6 is supplied to the tub 2 in a hot air state through the second air supply flow passage 7b connected to the tub 2 of the washing machine. The hot air is supplied to the drum 3 to dry the laundry through holes in the washing and drying combination drum 3.

During the drying process, the hot air supplied to the washing and drying combination drum 3 becomes humidified and full of moisture because of the wet laundry. The moisture rich air is then discharged from the washing and drying combination drum 3 through the second exhaust flow passage 9b , the second flow passage control valve 10 and the exhaust fan 11 to the outside of the single body washing machine and dryer through an outlet of the exhaust duct 9.

The process of circulating hot air into and out of the washing and drying combination drum 3 is continuously performed until the laundry reaches a desired degree of dryness.

It is preferable that the washing and drying combination drum driving motor 4 is driven to rotate the washing and drying combination drum 3 during the drying cycle to supply a uniform stream of hot air to minimize drying time of the laundry.

The drying cycle performed only in the combination washing machine component is advantageous in that laundry reaches its desired degree of dryness faster due to the size of the heater. Because the heater is shared with a dryer that is exclusively for drying laundry, the size of the heater is larger.

Another embodiment of the present invention will be described, in which the drying cycle is performed only at the dryer portion of the single body washing machine and dryer device.

If the user selects a drying cycle at the control panel 15, to be performed only at the dryer component, the microcomputer sends a control signal to the first flow passage control valve 8 on the hot air guide duct 7 to close the second air supply flow passage connected to the tub 2 of the washing machine, and to open the first air supply flow passage 7a connected to the drying drum 5.

A control signal is also sent to the second flow passage control valve 10 on the exhaust duct 9 to close the second exhaust flow passage 9b connected to the tub 2, and to open the first exhaust flow passage connected to the rear of the drying drum 5. The exhaust fan 11 and the heater 6 are also turned on by the microcomputer.

After the exhaust fan 11 is turned on, external air is drawn into the cabinet and heated by the heater. The heated air is supplied to the drying drum 5 through the first air supply flow passage 7a of the hot air guide duct 7. The heated air first passes through the rear supporter 14 which supports the drying drum 5 before being supplied to the drying drum through the hot air inlet holes 14 a in the rear supporter.

The hot air supplied to the drying drum 5 becomes humidified and full of moisture during the drying process. The moisture rich air is discharged from the drying drum 5 through the first exhaust flow passage 9a, the second flow passage control valve 10 and the exhaust fan 11 before being discharged to the outside of the cabinet through an outlet of the exhaust duct 9.

The process of circulating hot air into and out of the drying drum 5 is continuously performed until the laundry reaches a desired level of dryness.

It is preferable that the drying drum be rotated by driving a motor during the drying cycle so that the hot air is supplied to the drum uniformly in order to maximize the drying process.

Another embodiment of the present invention will be described, in which the drying process is performed at the washing machine and the dryer at the same time.

If the user selects a drying cycle at the control panel 15 to be performed both at the washing machine and the dryer simultaneously, the microcomputer sends a control signal to the first flow passage control valve 8 on the hot air guide duct 7 to open the first air supply flow passage 7a and the second air supply flow passage 7b connected to the drying drum 5 and the washing and drying combination drum 3 simultaneously.

A control signal is also sent to the second flow passage control valve 10 on the exhaust duct to open the first exhaust flow passage 9b connected to the washing and drying combination drum 3 and the second exhaust flow passage 9a connected to the drying drum 5 simultaneously. The exhaust fan 11 and the heater 6 are also turned on by a control signal from the microcomputer.

The external air, drawn through the external air inlet 19 in the rear of the cabinet. 1 by the exhaust fan 11 is introduced into the hot air guide duct 7. The external air is heated by the heater and is supplied to the drying drum 5 of the dryer and the washing and drying combination drum 3 of the washing machine through the second air supply flow passage 7b connected to the tub 2 of the washing machine and the first air supply flow passage 7a connected to the drying drum 5 of the dryer in a hot air state, respectively.

In this embodiment, the heated air is split into the two air supply flow passages 7a and 7b as the hot air passes through the first flow passage control valve 8.

The hot air supplied to the inside of the washing and drying drum 3 and the drying drum 5. During the drying process, the heated air is humidified because of the wet laundry. The moisture rich air is discharged from the drying drum 5 and the washing and drying combination drum 3 in through the first exhaust flow- passage 9a at the lower side of the front side of the dryer and the second exhaust flow passage 9b connected to an upper side of the front side of the washing machine.

The moisture rich air in the first and second exhaust flow passages 9a and 9b converge at the second flow passage control valve 10. The air is then discharged outside the cabinet through an outlet of the exhaust duct 9 at a lower side of the cabinet 1 via the exhaust fan 11.

The process of circulating hot air into and out of the drying drum 5 and the washing and drying combination drum 3 is continuously performed until the laundry reaches a desired level of dryness.

The drying cycle may terminate automatically after a predetermined time period has elapsed.- The drying cycle may also terminate when the laundry reaches a desired level of dryness, wherein the level of dryness is determined by continuously monitoring the moisture level of the laundry with a sensor (not shown).

It is preferable that the washing and drying combination drum 3 and the drying drum 5 be rotated by driving a motor during the drying cycle so that hot air is supplied to the drums uniformly in order to maximize the drying process.

It will be apparent to those skilled in the art that various modifications and variations can be made in the present invention without departing from the spirit or scope of the inventions.

For example, even though FIG. 4 shows that the second air supply flow passage 7b projects beyond the cabinet 1, the second air supply flow passage 7b may be mounted within the cabinet such that the second air supply flow passage 7b does not project beyond the cabinet.

Moreover, in a case the drying drum 5 and the rear supporter 14 in FIG. 4 are fabricated separately, a connection portion between the end portion of the second air supply flow passage 7b and the drying drum 5 (i.e., a drying drum having the rear supporter portion in FIG. 4 presently is fabricated as one body) may be fabricated to have a structure in which the connection portion is sealed to prevent leakage, wherein the connection portion does not hinder the rotation of the drying drum 5.

What is claimed is:

1. A single body washing machine and dryer device comprising:
a cabinet for forming an inside space;
a tub on one side of the inside space of the cabinet;
a washing and drying combination drum rotatably mounted in the tub;
a drying drum rotatably mounted on the other side of the inside space of the cabinet; and
a heater for supplying hot air to the drying drum or the washing and drying drum selectively, or at the same time.

2. The device of claim 1, wherein the tub is provided on a lower side of the inside space of the cabinet, and the drying drum is provided on an upper side of the inside space of the cabinet.

3. The device of claim 2, further comprising a hot air guide duct for guiding the hot air produced by the heater to the drying drum and the washing and drying combination drum, respectively.

4. The device of claim 3, further comprising a first flow passage control valve mounted on the hot air guide duct for controlling a flow passage of the hot air to supply the hot air to the drying drum or the washing and drying combination drum selectively, or at the same time.

5. The device of claim 4, wherein the heater is mounted at an inlet to the hot air guide duct for producing the hot air.

6. The device of claim 5, wherein the hot air guide duct includes:
a first air supply flow passage connected to a rear side of the drying drum and
a second air supply flow passage connected to an upper side of the tub.

7. The device of claim 6, further comprising a front supporter and a rear supporter at a front and a rear of the drying drum for supporting opposite edges of the drying drum which is rotatable.

8. The device of claim 7, wherein the hot air guide duct has the other end connected to the rear supporter which has holes formed therein for spreading and introducing the hot air into the drying drum.

9. The device of claim 8, further comprising an exhaust duct for discharging moisture rich air from the drying drum or the washing and drying drum to an outside of the cabinet.

10. The device of claim 9, further comprising a second flow passage control valve on the exhaust duct for controlling a flow passage of moisture rich air discharged from the drying drum or the washing and drying drum selectively, or at the same time.

11. The device of claim 10, further comprising an exhaust fan on the exhaust duct for providing a suction force for supplying the hot air to the drying drum and the washing and drying combination drum, and discharging the moisture rich air.

12. The device of claim 11, wherein the exhaust duct includes a first exhaust flow passage connected to a lower side of the drying drum, and a second exhaust flow passage connected to an upper side of the washing and drying combination drum.

13. The device of claim 12, wherein the flow control valves on the hot air guide duct and the exhaust duct are three way valves.

14. The device of claim 13, wherein the cabinet includes a control panel mounted on a front for individual control of a drying function and a washing and drying function and display of states.

15. A method for controlling a single body washing machine and drying device comprising the steps of:
a user selecting one of steps through a control panel from a step for drying only with a washing and drying drum, a step for drying only with a drying drum, and a step for drying with the washing and drying drum and the drying drum at the same time; operating a heater and an exhaust fan, and a microcomputer configured to control a first flow passage control valve on a hot air duct, and a second flow passage control valve on an exhaust duct according to a drying step selected as above; and drying laundry and finishing the drying step.

16. The method of claim 15, wherein the step of drying only with the washing and drying drum includes the steps of:
opening the first flow passage control valve of the second air supply flow passage on a side of the washing and drying combination drum, and closing a first air supply flow passage on a side of the drying drum; and
opening the second flow passage control valve of the second exhaust flow passage on a side of the washing and drying combination drum and closing the first exhaust flow passage on a side of the drying drum.

17. The method of claim 15, wherein the step for drying only with a drying drum includes the steps of:
opening the first flow passage control valve to the first air supply flow passage, and closing the second air supply flow passage; and
opening the second flow passage control valve to the first exhaust flow passage and closing the second exhaust flow passage.

18. The method of claim 15, wherein the step for drying with the washing and drying combination drum and the drying drum at the same time includes the steps of:
opening the first flow passage control valve to both the first air supply flow passage and the second air supply flow passage; and
opening the second flow passage control valve to both the first exhaust flow passage and the second exhaust flow passage.

19. The method of claim 15, wherein the finishing of the drying step is performed after a predetermined time period.

20. The method of claim 15, wherein the finishing of the drying step is performed after a desired dryness is reached when a sensor detects a dry state of the laundry.
